(19) United States
(12) Patent Application Publication
(10) Pub. No.: US 2024/0402563 A1
(43) Pub. Date: Dec. 5, 2024

(54) Electrophoretic Display Substrate and Manufacturing Method thereof, and a Electrophoretic Display Device

(71) Applicants: Beijing BOE Optoelectronics Technology Co., Ltd., Beijing (CN); BOE Technology Group Co., Ltd., Beijing (CN)

(72) Inventors: Junru MA, Beijing (CN); Hanqing LIU, Beijing (CN); Wei CHEN, Beijing (CN); Yuxuan WEI, Beijing (CN); Hongwen GUO, Beijing (CN); Lei MAO, Beijing (CN); Xin LI, Beijing (CN); Pengcheng TIAN, Beijing (CN); Haowei ZOU, Beijing (CN)

(21) Appl. No.: 18/273,532

(22) PCT Filed: Jul. 8, 2022
(86) PCT No.: PCT/CN2022/104677

§ 371 Date: Jul. 20, 2023

(51) Int. Cl. G02F 1/1685; G02F 1/167; G02F 1/16756

(52) U.S. Cl. CPC G02F 1/1685; G02F 1/167; G02F 1/16756

(57) ABSTRACT

A display substrate includes: a base substrate (300), a circuit structure layer (400) and an electronic paper film (500) sequentially disposed on the base substrate (300). The circuit structure layer (400) includes: a plurality of first signal lines (21) extending along a first direction (X), a plurality of second signal lines (22) extending along a second direction (Y), a plurality of drive units, and at least one near field communication coil. The plurality of first signal lines (21) and the plurality of second signal lines (22) intersect to form a plurality of sub-pixel areas. The drive units are located in the sub-pixel area and electrically connected with the first signal lines (21) and the second signal lines (22), and are configured to control the display patterns of the electronic paper film corresponding to the sub-pixel areas.

### CROSS-REFERENCE TO RELATED APPLICATION

The present application is a U.S. National Phase Entry of International Application No. PCT/CN2022/104677 having an international filing date of Jul. 8, 2022. The above-identified application is hereby incorporated by reference.

### TECHNICAL FIELD

The present disclosure relates to, but is not limited to, the field of display technologies, and in particular to a display substrate and a display device.

### BACKGROUND

Electrophoretic Display (EPD) is a kind of paper-like display. Its working principle is that black color and white color are formed through the occurrence of electrophoresis of black particles and white particles under an action of a voltage. Because of its own reflective and bistable display principle, Electrophoretic Display accordingly has the characteristics of eye protection and energy saving, has gradually entered fields of education, medical treatment and transportation from a price tag market, and has potential application value. However, an interaction capability of traditional Electrophoretic Display products is poor.

### SUMMARY

The following is a summary of subject matters described herein in detail. The summary is not intended to limit the protection scope of claims.

Embodiments of the present disclosure provide a display substrate and a display device.

In one aspect, an embodiment of the present disclosure provides a display substrate including a base substrate, and a circuit structure layer and an electronic paper film sequentially disposed on the base substrate. The circuit structure layer includes a plurality of first signal lines extending along a first direction, a plurality of second signal lines extending along a second direction, a plurality of drive units, and at least one near field communication coil. The first direction intersects with the second direction. The plurality of first signal lines and the plurality of second signal lines intersect to form a plurality of sub-pixel areas. The drive units are located in the sub-pixel areas and electrically connected with the first signal lines and the second signal lines. The drive units are configured to control display patterns of the electronic paper film corresponding to the sub-pixel areas. The near field communication coil may include at least one first communication line extending along the first direction and at least one second communication line extending along the second direction. The at least one first communication line is electrically connected with the at least one second communication line.

In some exemplary embodiments, at least one first signal line is adjacent to the first communication line in the second direction, and at least one second signal line is adjacent to the second communication line in the first direction.

In some exemplary embodiments, at least one sub-pixel area is spaced between two adjacent first communication lines in the second direction, and at least one sub-pixel area is spaced between two adjacent second communication lines in the first direction.

In some exemplary embodiments, the at least one first communication line is located on a side of the at least one second communication line close to the base substrate; the plurality of first signal lines are located on a side of the plurality of second signal lines close to the base substrate.

In some exemplary embodiments, the at least one second signal line and the plurality of second signal lines are of a same layer structure.

In some exemplary embodiments, the at least one first communication line and the plurality of first signal lines are of a same layer structure.

In some exemplary embodiments, the at least one first communication line is located on a side of the plurality of first signal lines away from the base substrate.

In some exemplary embodiments, the at least one first communication line includes a plurality of first sub-communication line segments extending along the first direction and sequentially arranged, two adjacent first sub-communication line segments are electrically connected by a first connection electrode located on a side of the first sub-communication line segment away from the base substrate.

In some exemplary embodiments, the base substrate includes at least one near field communication area and at least one non-near field communication area; the at least one near field communication coil is located within the at least one near field communication area, and the at least one non-near field communication area is provided with at least one first dummy communication line extending along the first direction and at least one second dummy communication line extending along the second direction; the first communication line is disconnected from the first dummy communication line, and the second communication line is disconnected from the second dummy communication line.

In some exemplary embodiments, the circuit structure layer further includes a plurality of touch signal lines and a plurality of touch electrodes; the plurality of touch signal lines extend along the second direction, and at least one touch signal line is electrically connected with the plurality of touch electrodes electrically connected with each other and spaced apart.

In some exemplary embodiments, the at least one second communication line is arranged at intervals among the plurality of touch signal lines, and at least one sub-pixel area is spaced between the second communication line and the touch signal line which are adjacent to each other.

In some exemplary embodiments, the drive unit at least includes a transistor and a pixel electrode; the pixel electrode is located in the sub-pixel area; a gate of the transistor is electrically connected with the first signal line, a first electrode of the transistor is electrically connected with the second signal line, and a second electrode of the transistor is electrically connected with the pixel electrode.

In some exemplary embodiments, in a direction perpendicular to the display substrate, the circuit structure layer includes a first conductive layer, a semiconductor layer, a first transparent conductive layer, a second conductive layer, and a second transparent conductive layer which are disposed sequentially on the base substrate. The first conductive layer at least includes: the plurality of first signal lines, a gate of the transistor of the drive unit. The semiconductor layer at least includes: an active layer of the transistor of the drive unit. The first transparent conductive layer includes: the plurality of touch electrodes. The second conductive layer at least includes the plurality of second signal lines, the at least one second communication line and the plurality of touch signal lines. The second transparent conductive layer at least includes the pixel electrode.

In some exemplary embodiments, the at least one first communication line is located in the first conductive layer or the first transparent conductive layer.

In some exemplary embodiments, an inorganic insulation layer and an organic insulation layer are disposed between the second conductive layer and the transparent conductive layer and the organic insulation layer is located on a side of the inorganic insulation layer away from the base substrate.

In some exemplary embodiments, the electronic paper film is configured to display using incident light from a side of the base substrate.

In another aspect, an embodiment of the present disclosure provides a display device, including the aforementioned display substrate.

In another aspect, an embodiment of the present disclosure provides a manufacturing method for a display substrate, including: forming a circuit structure layer on a base substrate, the circuit structure layer includes a plurality of first signal lines extending along the first direction, a plurality of second signal lines extending along the second direction, a plurality of drive units, and at least one near field communication coil; the first direction intersects with the second direction; the plurality of first signal lines and the plurality of second signal lines intersect to form a plurality of sub-pixel areas; the drive units are located in the sub-pixel areas and electrically connected with the first signal lines and the second signal lines; the near field communication coil includes: at least one first communication line extending along the first direction and at least one second communication line extending along the second direction, the at least one first communication line is electrically connected with the at least one second communication line; an electronic paper film is disposed on a side of the circuit structure layer away from the base substrate; the drive units of the circuit structure layer is configured to control the display pattern of the electronic paper film corresponding to the sub-pixel areas.

In some exemplary embodiments, forming the circuit structure layer on the base substrate includes: forming a first conductive layer, a first insulation layer, a semiconductor layer, a first transparent conductive layer, a second conductive layer, a second insulation layer, a third insulation layer, and a second transparent conductive layer on the base substrate sequentially. The first conductive layer at least includes: the plurality of first signal lines, the gates of the transistors of the drive units; the semiconductor layer at least includes: active layers of the transistors of the drive units; the first transparent conductive layer at least includes a plurality of touch electrodes; the second conductive layer at least includes: the plurality of second signal lines, the at least one second communication line and a plurality of touch signal lines, the first electrodes and the second electrodes of the transistors of the drive units; the second transparent conductive layer at least includes: a plurality of pixel electrodes.

In some exemplary embodiments, the transistors of the drive units and the first signal lines are of an integrated structure, the first electrodes of the transistors of the drive units and the second signal lines are of an integrated structure, and the second electrodes of the transistor are electrically connected with the pixel electrodes.

Other aspects may be understood upon reading and understanding the drawings and detailed description.

### BRIEF DESCRIPTION OF DRAWINGS

Accompanying drawings are used for providing further understanding for technical solutions of the present disclosure, and constitute a part of the specification. They are used for explaining the technical solutions of the present disclosure together with embodiments of the present disclosure, but do not constitute a limitation on the technical solutions of the present disclosure. Shapes and sizes of one or more components in the drawings do not reflect true scales, and are only intended to schematically describe contents of the present disclosure.

FIG. 1 is a schematic diagram of a display substrate according to at least one embodiment of the present disclosure.

FIG. 2 is a schematic partial sectional view of a display substrate according to at least one embodiment of the present disclosure.

FIG. 3 is a schematic diagram of a display area of a display substrate according to at least one embodiment of the present disclosure.

FIG. 4 is a partial schematic diagram of a circuit structure layer of a near field communication area according to at least one embodiment of the present disclosure.

FIG. 5 is a schematic diagram of the circuit structure layer after a second conductive layer is formed in FIG. 4.

FIG. 6 is a partial schematic diagram of a circuit structure layer of a display area according to at least one embodiment of the present disclosure.

FIG. 7 is a schematic partial sectional view along a Q-Q′ direction in FIG. 6.

FIG. 8A is a partial schematic diagram of the circuit structure layer after a first conductive layer is formed in FIG. 6.

FIG. 8B is a partial schematic diagram of the circuit structure layer after a semiconductor layer is formed in FIG. 6.

FIG. 8C is a partial schematic diagram of the circuit structure layer after a first transparent conductive layer is formed in FIG. 6.

FIG. 8D is a partial schematic diagram of the circuit structure layer after a second conductive layer is formed in FIG. 6.

FIG. 8E is a partial schematic diagram of the circuit structure layer after a third insulation layer is formed in FIG. 6.

FIG. 9A is a partial schematic diagram of a circuit structure layer of a display area according to at least one embodiment of the present disclosure.

FIG. 9B is a schematic diagram of the circuit structure layer after a second conductive layer is formed in FIG. 9A.

FIG. 10 is a schematic partial sectional view along an R-R′ direction in FIG. 9A.

FIG. 11A is a partial schematic diagram of a circuit structure layer of a display area according to at least one embodiment of the present disclosure.

FIG. 11B is a schematic diagram of the circuit structure layer after a second conductive layer is formed in FIG. 11A.

FIG. 12A is another partial schematic diagram of a circuit structure layer of a display area according to at least one embodiment of the present disclosure.

FIG. 12B is a schematic diagram of the circuit structure layer after a second conductive layer is formed in FIG. 12A.

FIG. 13A is another schematic diagram of a circuit structure layer of a display area according to at least one embodiment of the present disclosure.

FIG. 13B is a schematic diagram of the circuit structure layer after a second conductive layer is formed in FIG. 13A.

FIG. 14 is a partially enlarged schematic diagram along a U-U′ direction in FIG. 13A.

FIG. 15 is another schematic diagram of a circuit structure layer of a display area according to at least one embodiment of the present disclosure.

FIG. 16 is a partially enlarged schematic diagram along a P-P′ direction in FIG. 15.

FIG. 17 is a schematic diagram of a display device according to at least one embodiment of the present disclosure.

### DETAILED DESCRIPTION

The embodiments of the present disclosure will be described below in combination with the drawings in detail. Embodiments may be implemented in a plurality of different forms. Those of ordinary skills in the art may easily understand such a fact that embodiments and contents may be transformed into one or more forms without departing from the purpose and scope of the present disclosure. Therefore, the present disclosure should not be explained as being limited to contents described in following embodiments only. The embodiments in the present disclosure and features in the embodiments may be combined randomly with each other if there is no conflict.

In the drawings, a size of one or more constituent elements, a thickness of a layer, or a region is sometimes exaggerated for clarity. Therefore, one implementation of the present disclosure is not necessarily limited to the dimensions, and shapes and sizes of a plurality of components in the accompanying drawings do not reflect actual scales. In addition, the drawings schematically illustrate ideal examples, and one mode of the present disclosure is not limited to shapes, numerical values, or the like shown in the drawings.

Ordinal numerals such as “first”, “second” and “third” in the present disclosure are set to avoid confusion of constituent elements, but not intended for restriction in quantity. “A plurality of” in the present disclosure means a quantity of two or more.

In the present disclosure, for convenience, wordings “central”, “up”, “down”, “front”, “back”, “vertical”, “horizontal”, “top”, “bottom”, “inside”, “outside” and the like indicating orientation or positional relationships are used to illustrate positional relationships between constituent elements with reference to the drawings, which are only to facilitate describing the present specification and simplify the description, rather than indicating or implying that involved devices or elements must have specific orientations and be structured and operated in the specific orientations, and thus should not be understood as limitations on the present disclosure. The positional relationships between the constituent elements are changed as appropriate based on directions for describing the constituent elements. Therefore, appropriate replacements may be made according to situations without being limited to the wordings described in the specification.

In the present disclosure, unless otherwise specified and defined, terms “mounting”, “mutual connection” and “connection” should be understood in a broad sense. For example, it may be a fixed connection, or a detachable connection, or an integrated connection. It may be a mechanical connection or an electrical connection. It may be a direct mutual connection, or an indirect connection through middleware, or internal communication between two elements. Those of ordinary skills in the art may understand meanings of the aforementioned terms in the present disclosure according to situations.

In the present disclosure, a transistor refers to an element including at least three terminals, namely, a gate electrode, a drain electrode and a source electrode. The transistor has a channel area between the drain electrode (drain electrode terminal, drain area, or drain) and the source electrode (source electrode terminal, source area, or source), and a current can flow through the drain electrode, the channel region and the source electrode. In the present disclosure, the channel area refers to an area which the current flows mainly through.

In the present disclosure, to distinguish two electrodes of a transistor except the gate electrode, one of the electrodes is referred to as a first electrode and the other electrode is referred to as a second electrode. The first electrode may be a source electrode or a drain electrode, and the second electrode may be a drain electrode or a source electrode. In addition, the gate electrode of the transistor is referred to as a control electrode. In cases that transistors with opposite polarities are used, a current direction changes during operation of a circuit, or the like, functions of the “source electrode” and the “drain electrode” are sometimes interchangeable. Therefore, the “source electrode” and the “drain electrode” are interchangeable in the present disclosure.

In the present disclosure, “electric connection” includes a case where constituent elements are connected through an element with a certain electrical effect. The “element with a certain electrical effect” is not particularly limited as long as electrical signals may be sent and received between the connected constituent elements. Examples of “an element with a certain electrical action” not only include electrodes and wirings, but also include switching elements such as transistors, resistors, inductors, capacitors, other elements with one or more functions, etc.

In the present disclosure, “parallel” refers to a state in which an angle formed by two straight lines is −10° or more and 10° or less, and thus may include a state in which the angle is-5° or more and 5° or less. In addition, “perpendicular” refers to a state in which an angle formed by two straight lines is 80° or more and 100° or less, and thus may include a state in which the angle is 85° or more and 95° or less.

In the present disclosure, “about” and “substantially” refer to that a boundary is not defined strictly and a case within a range of a process and measurement error is allowed.

Near Field Communication (NFC) technology, also known as close distance wireless communication, is a new communication technology, which combines non-contact induction technology and wireless connection technology. It can achieve data transmission and exchange in close distance, and has the advantages of high transmission security and quick response. It is gradually being used in mobile payment, identity recognition, anti-counterfeiting, access control and so on.

This embodiment provides a display substrate, which can integrate NFC function, thereby improving the interaction capability of a display product.

This embodiment provides a display substrate, which includes a base substrate, a circuit structure layer and an electronic paper film sequentially disposed on the base substrate. The circuit structure layer includes a plurality of first signal lines extending in a first direction, a plurality of second signal lines extending in a second direction, a plurality of drive units, and at least one near field communication coil. The first direction intersects with the second direction, for example, the first direction may be perpendicular to the second direction. The plurality of first signal lines 21 and the plurality of second signal lines 41 intersect to form a plurality of sub-pixel areas. The drive unit may be located in the sub-pixel area and electrically connected with the first signal line and the second signal line. The drive unit is configured to control the display pattern of the electronic paper film corresponding to the sub-pixel area. The near field communication coil may include at least one first communication line extending in a first direction and at least one second communication line extending in a second direction. At least one first communication line is electrically connected with at least one second communication line.

In the display substrate provided by this embodiment, the first communication lines and the second communication lines can be arranged in a mesh structure and electrically connected to form a near field communication coil of the mesh structure, so as to support the implementation of an integrated NFC function inside the display substrate.

In some exemplary embodiments, at least one first signal line is adjacent to a first communication line in a second direction, and at least one second signal line is adjacent to a second communication line in a first direction. In this example no other devices or lines are provided between adjacent first signal lines and first communication lines in the second direction; in the first direction, no other devices or lines are provided between the adjacent second signal lines and the second communication lines. In this example, by disposing the first communication line adjacent to the first signal line and the second communication line adjacent to the second signal line, reasonable arrangement of the near field communication coil in the display area can be achieved.

In some exemplary embodiments, at least one sub-pixel area may be spaced between two adjacent first communication lines in the second direction, and at least one sub-pixel area may be spaced between two adjacent second communication lines in the first direction. In some examples, a second communication line may be arranged between at least two columns of adjacent sub-pixel areas in the first direction, and a first communication line may be arranged between at least two rows of adjacent sub-pixel areas in the second direction.

In some exemplary embodiments, at least one first communication line may be located on a side of at least one second communication line close to the base substrate. The plurality of first signal lines may be located on a side of the plurality of second signal lines close to the base substrate. For example, the at least one second communication line and the plurality of second signal lines may be of a same layer structure. In some examples, the at least one first communication line and the plurality of first signal lines may be of a same layer structure; alternatively, the at least one first communication line may be located on a side of the plurality of first signal lines away from the base substrate. However, this embodiment is not limited thereto.

In some exemplary embodiments, the circuit structure layer may further include a plurality of touch signal lines and a plurality of touch electrodes. The plurality of touch signal lines may extend in the second direction, and at least one touch signal line may be electrically connected with the plurality of touch electrodes electrically connected to each other and spaced apart. The plurality of touch electrodes are electrically connected to form a touch sensing area. The display substrate of this example can integrate NFC function and touch function, thus improving interaction capability of display products.

In some exemplary embodiments, at least one second communication line may be spaced between a plurality of touch signal lines, and at least one sub-pixel area may be spaced between adjacent second communication line and touch signal line.

Solutions of the embodiments will be described below through some examples.

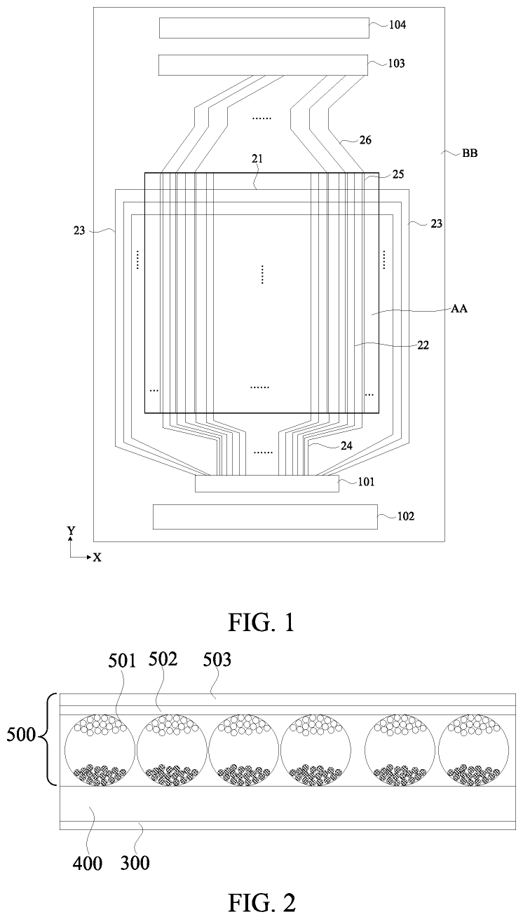

FIG. 1 is a schematic diagram of a display substrate according to at least one embodiment of the present disclosure. In some examples as shown in FIG. 1, the display substrate may include a display area AA and a peripheral area BB surrounding the display area AA. The display area AA may be provided with the plurality of first signal lines 21 extending in the first direction X and the plurality of second signal lines 22 extending in the second direction Y. The first direction X intersects with the second direction Y, for example, the first direction X may be perpendicular to the second direction Y. The plurality of first signal lines 21 may be sequentially arranged in the second direction Y, and the plurality of second signal lines 22 may be sequentially arranged in the first direction X. The plurality of first signal lines 21 and the plurality of second signal lines 22 intersect to form a plurality of sub-pixel areas. In some examples, the plurality of first signal lines 21 may include a plurality of scan lines and the plurality of second signal lines 22 may include a plurality of data lines.

In some examples, as shown in FIG. 1, the peripheral area BB may include an upper bezel located on an upper side of the display area AA, a lower bezel located on a lower side of the display area AA, a left bezel located on a left side of the display area AA, and a right bezel located on a right side of the display area AA. The upper bezel can communicate with the left bezel and the right bezel, and the lower bezel can communicate with the left bezel and the right bezel. The peripheral area BB may be disposed with a plurality of first lead lines 23 and a plurality of second lead lines 24. The plurality of first lead lines 23 may be located on the left bezel and the right bezel and the plurality of second lead lines 24 may be located on the lower bezel. One end of a first signal line 21 may be electrically connected with a first lead line 23 of the left bezel and the other end may be electrically connected with a first lead line 23 of the right bezel so as to receive a signal through the first lead line 23. The first lead line 23 may extend from the left bezel or the right bezel to the lower bezel. A second lead line 24 may be electrically connected with an end of a second signal line 22 extending toward the lower bezel to provide a signal to the second signal line 22.

In some examples, as shown in FIG. 1, the lower bezel may include a first circuit region 101 and a first bonding area 102. The first bonding area 102 may be located on a side of the first circuit region 101 away from the display area AA. The first circuit region 101 may be disposed with a display control circuit. The first lead line 23 and the second lead line 24 may extend to the first circuit region 101 and are electrically connected with the display control circuit. The first bonding area 102 may be disposed with a plurality of first bonding pins which may be bound to a flexible printed circuit (FPC) providing display control.

In some examples, the display area AA may further include a plurality of drive units, the plurality of drive unit may be distributed in an array. For example, each drive unit may be located in a sub-pixel area. Each drive unit can be in contact with an electronic paper film of a corresponding sub-pixel area, and can control the display pattern of the electronic paper film in the corresponding sub-pixel area. Each drive unit may include at least one transistor and pixel electrodes. A gate of the transistor may be electrically connected with the first signal line, a first electrode may be electrically connected with the second signal line, and a second electrode may be electrically connected with the pixel electrode. For example, the first signal line may provide a scan signal and the second signal line may provide a data signal. Each transistor may function as a switch so that when a signal is supplied to the first signal line (e.g., a scan line) and the second signal line (e.g., a data line), the transistor may be in an on state, and a voltage may be applied to a pixel electrode when the transistor is in an on state.

In some examples, as shown in FIG. 1, the display area AA may further include a plurality of touch electrodes arranged in an array (as self-capacitive electrodes), and a touch signal line 25 electrically connected with the touch electrodes. An orthographic projection of a touch electrode on the base substrate may be overlapped with an orthographic projection of the pixel electrode on the base substrate. A plurality of touch signal lines 25 may be sequentially arranged in a first direction X and extend in a second direction Y. The peripheral area BB may be provided with a plurality of touch lead lines 26. The plurality of touch lead lines 26 may be located on the upper bezel.

In some examples, as shown in FIG. 1, the upper bezel may include a second circuit region 103 and a second bonding area 104. The second bonding area 104 may be located on a side of the second circuit region 103 away from the display area AA. The second circuit region 103 may be provided with a touch control circuit. A touch lead line 26 may extend to the second circuit region 103 and be electrically connected with the touch control circuit. The second bonding area 104 may be disposed with a plurality of second bonding pins, the plurality of second bonding pins may be bound to the flexible printed circuit providing touch control. The touch electrode may be electrically connected with the touch control circuit through the touch signal line 25 and the touch lead line 26. When a touch is performed, a touch object (such as a human finger) touches a display device, the capacitance of the touch electrode located at a touch point will change. The touch control circuit determines a touch position by detecting a change in the self-capacitance of the touch electrode. However, this embodiment is not limited thereto. In some other examples, the display control circuit and the touch control circuit may be integrated into one display touch control circuit, the display touch control circuit may be disposed in the lower bezel or the upper bezel.

The display substrate of this embodiment can adopt a self-capacitive touch control technology. In the touch stage, a touch signal detected by the touch electrode is transmitted by the touch signal line to achieve the touch function. In some examples, the plurality of touch electrodes may be electrically connected to form a touch sensing area, for example, a touch sensing area may include touch electrodes of tens by tens of sub-pixel areas. For example, a touch sensing area can be about 4 millimeter (mm) in length and can include touch electrodes located in 25 to 40 sub-pixel areas. The plurality of touch electrodes in each touch sensing area can be electrically connected with a touch signal line. In some examples, the touch electrodes can be multiplexed into common electrodes, and in the display stage, a common voltage can be provided to the common electrodes through the touch signal lines to achieve the display function.

FIG. 2 is a schematic partial sectional view of a display substrate according to at least one embodiment of the present disclosure. In some examples, as shown in FIG. 2, in a direction perpendicular to the display substrate, the display substrate may include a base substrate 300, and a circuit structure layer 102 and an electronic paper film which are disposed sequentially on the base substrate 300. The electronic paper film 500 may be disposed on a side of the circuit structure layer 400 away from the base substrate 300 through an adhesive layer.

In some examples, as shown in FIG. 2, the electronic paper film 500 may include an ink layer 501, a control electrode 502 and a protective film 503. The ink layer 501 may exhibit a color pattern or black-and-white pattern by motion of particles according to an applied electric field (i.e. an electrophoretic phenomenon) and display the pattern by reflection or absorption of external light incident on the pattern. For example, the ink layer 501 includes a plurality of microcapsules and the microcapsules are transparent fluids including white particles and black particles. A black or white pattern is exhibited by applying an electric field to the plurality of microcapsules. For example, white particles are charged (+) and black particles are charged (−) so that they are motioned along opposite directions by applying an electric field. The image pattern of the ink layer can be maintained until an electric field change point. In some other examples, color display may be achieved by stacking color filters on the ink layer or by using color particles instead of black and white particles. The control electrode 502 of the electronic paper film 500 may serve as a common electrode providing a common voltage Vcom. For example, the control electrode 502 may remain a constant electrode and may be connected to ground. An electric field generated between the control electrode 502 and the pixel electrode of the circuit structure layer can push the movement of charged particles. In some examples, the control electrode 502 may be electrically connected with a common electrode of the circuit structure layer.

In some examples, the electronic paper film 500 may be configured to display with light incident on a side of the base substrate 300. In this example, the display substrate can be used in an inverted manner. During use, the base substrate is facing the user and the electronic paper film 500 is displayed on a side close to the base substrate 300, so that the user can observe the display pattern of the electronic paper film 500 through the base substrate 300.

In some examples, the display substrate may have near field communication coils in the display area to integrate NFC function. For example, when a changing current passes through the near field communication coil of a terminal device initiating a connection, a magnetic field will be generated, and the magnetic field will be electromagnetically coupled with an induced magnetic field of a target terminal device to be connected, so that the two devices can be successfully paired and connected, and data exchange can be carried out. In some examples, the touch control circuit disposed in the second circuit region 103 may be integrated with the NFC control circuit, and the near field communication coil of the display area may be electrically connected with the touch control circuit of the second circuit region 103 through the lead line located in the upper bezel. However, this embodiment is not limited thereto. For example, the NFC control circuit may be integrated with the display control circuit, or the NFC control circuit, the display control circuit, and the touch control circuit may be integrated on the upper bezel or the lower bezel.

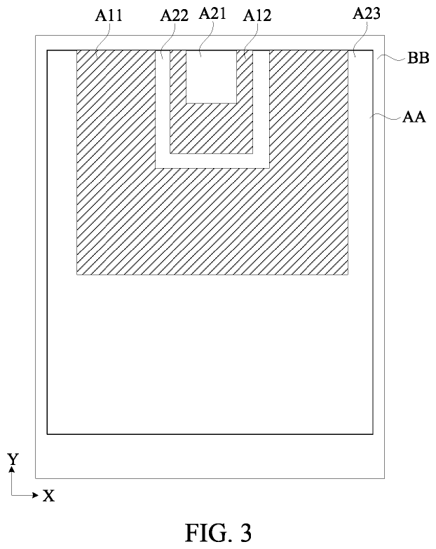

FIG. 3 is a schematic diagram of a display area according to at least one embodiment of the present disclosure. In some examples, as shown in FIG. 3, the display area AA may include two near field communication areas (e.g., a first near field communication area A11 and a second near field communication area A12) and three non-near field communication areas (e.g., a first non-near field communication area A21, a second non-near field communication area A22 and a third non-near field communication area A23). The orthographic projection of the first near field communication area A11 and the second near field communication area A12 may have a U-shape on the base substrate and the second near field communication area A12 may be located inside the first near field communication area A11. The first non-near field communication area A21 may be located inside the first near field communication area A12, the second non-near field communication area A22 may be located between the first near field communication area A11 and the second near field communication area A12, and the third non-near field communication area A23 may be located on a side of the first near field communication area A11 away from the second near field communication area A12. However, this embodiment is not limited thereto. In this example, by disposing the plurality of near field communication areas, it is beneficial to improve the communication quality.

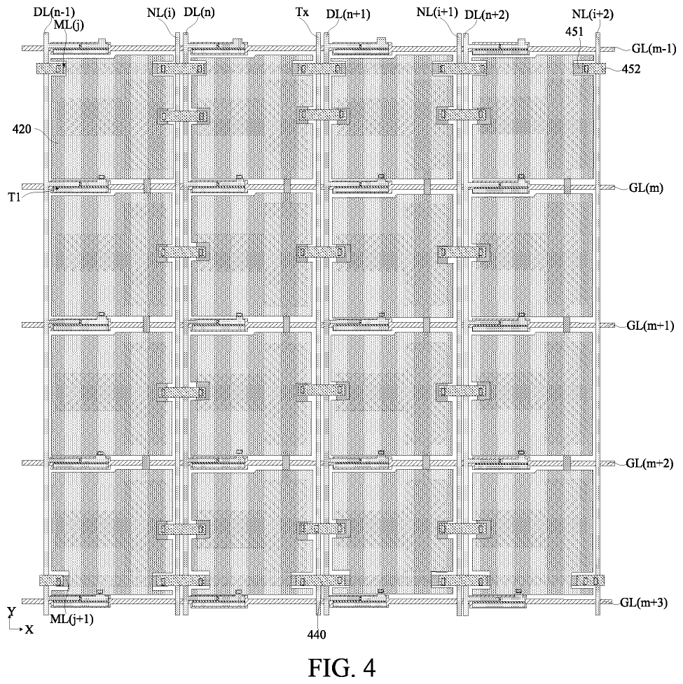

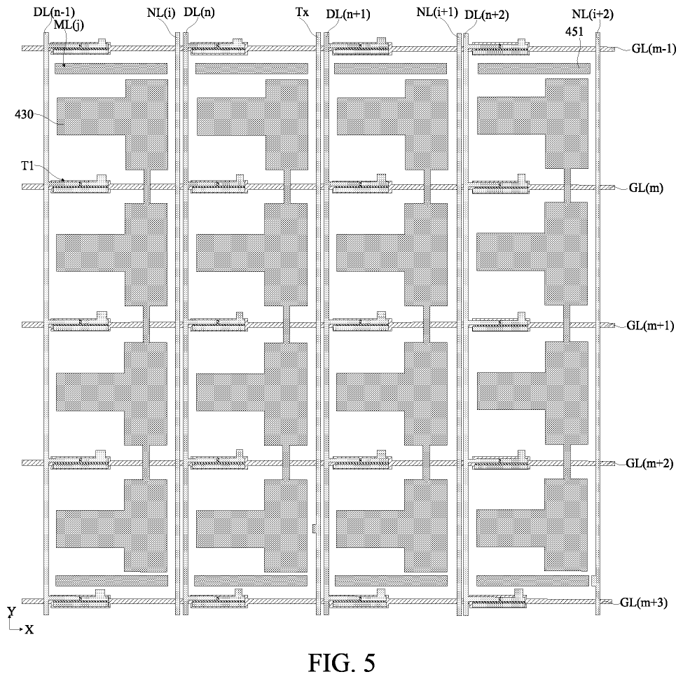

FIG. 4 is a partial schematic diagram of a near field communication area according to at least one embodiment of the present disclosure. FIG. 5 is a schematic diagram of the circuit structure layer after a second conductive layer is formed in FIG. 4. FIG. 4 shows sub-pixel areas arranged in 4×4 within one near field communication area of the display area. In some examples, as shown in FIG. 4, the near field communication area may include a plurality of first communication lines (e.g., first communication lines ML (j) and ML (j+1)) extending in the first direction X, a plurality of second communication lines (e.g., second communication lines NL (i) to NL (i+2)) extending in the second direction Y, a plurality of first signal lines (e.g., including scan lines GL (m−1) to GL (m+3)) extending in the first direction X, a plurality of second signal lines (e.g., including data lines DL (n−1) to DL (n+2)) extending in the second direction Y, and a touch signal line Tx extending in the second direction Y. Where i, j, m, and n may all be positive integers.

In some examples, as shown in FIG. 4, a plurality of scan lines and a plurality of data lines intersect to form a plurality of sub-pixel areas. At least one scan line may be adjacent to the first communication line in the second direction Y. For example, a scan line GL (m−1) may be adjacent to a first communication line ML (j) and a scan line GL (m+3) may be adjacent to a first communication line ML (j+1). Four rows of sub-pixel areas may be spaced between two adjacent first communication lines (e.g., ML (j) and ML (j+1)). However, this embodiment is not limited thereto. For example, a row of sub-pixel areas may be spaced between two adjacent first communication lines.

In some examples, as shown in FIG. 4, at least one data line may be adjacent to a second communication line or the touch signal line in the first direction X. For example, a data line DL (n) may be adjacent to a second communication line NL (i), a data line DL (n+1) may be adjacent to a touch signal line Tx, and a data line DL (n+2) may be adjacent to a second communication line NL (i+1). For example, the touch signal line Tx may be electrically connected with 4×4 touch electrodes 430. As shown in FIG. 4 and FIG. 5, among the 4×4 touch electrodes 430, the touch electrodes 430 adjacent in the second direction Y may form an integral structure, and the touch electrodes 430 adjacent in the first direction X may be electrically connected through the second connection electrode 440. The second connection electrode 440 electrically connected with the touch electrodes 430 of the fourth row and the second column and the touch electrodes 430 of the fourth row and the third column may be electrically connected with the touch signal line Tx simultaneously, thereby achieving the electrical connection between the touch signal line Tx and the plurality of touch electrodes 430.

In some examples, as shown in FIG. 4 and FIG. 5, at least a column of sub-pixel areas is spaced between adjacent second communication line and touch signal line Tx. For example, the second communication lines NL (i) and NL (j+1) are located on both sides of the touch signal line Tx in the first direction X and are separated from the touch signal line Tx by a column of sub-pixel areas. However, this embodiment is not limited thereto.

In some examples, as shown in FIG. 4 and FIG. 5, a data line and a touch signal line may be disposed between two adjacent columns of sub-pixel areas, or a data line and a second communication line may be disposed. A scan line may be disposed between two adjacent rows of sub-pixel areas, or a scan line and a first communication line may be disposed between two adjacent rows of sub-pixel areas. The wiring arrangement of this embodiment can save space and avoid route aggregation and signal interference.

In some examples, as shown in FIG. 4, taking a first communication line ML (j) as an example, the first communication line ML (j) may include a plurality of first sub-communication line segments 451 sequentially arranged in the first direction X, and adjacent first sub-communication line segments 451 may be electrically connected by the first connection electrode 452. The first communication line ML (j+1) may be electrically connected with the second communication line NL (i+2) through the first connection electrode 452, thereby achieving a mesh connection between the first communication line and the second communication line. The near field communication coil of this example may have a mesh structure.

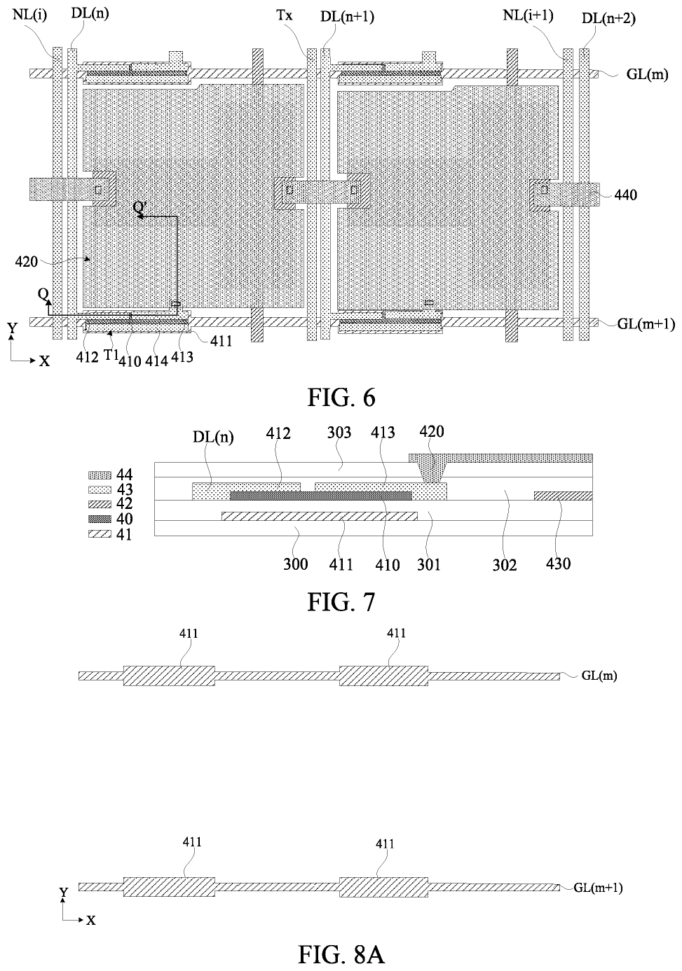

FIG. 6 is a partial schematic diagram of a circuit structure layer of a display area according to at least one embodiment of the present disclosure. FIG. 6 shows a schematic diagram of two sub-pixel areas of the second row and the second column and the second row and the third column in FIG. 4. FIG. 7 is a schematic partial sectional view along a Q-Q′ direction in FIG. 6.

In some examples, as shown in FIG. 6 and FIG. 7, in a direction perpendicular to the display substrate, the circuit structure layer of the display area may include: a first conductive layer 41, a semiconductor layer 40, a first transparent conductive layer 42, a second conductive layer 43, and a second transparent conductive layer 44 that are disposed sequentially on the base substrate 300. A first insulation layer 301 may be disposed between the first conductive layer 41 and the semiconductor layer 40 and a second insulation layer 302 and a third insulation layer 303 may be disposed between the second conductive layer 43 and the second transparent conductive layer 44. For example, the first insulation layer 301 and the second insulation layer 302 may be inorganic insulation layers and the third insulation layer 303 may be an organic insulation layer. However, this embodiment is not limited thereto.

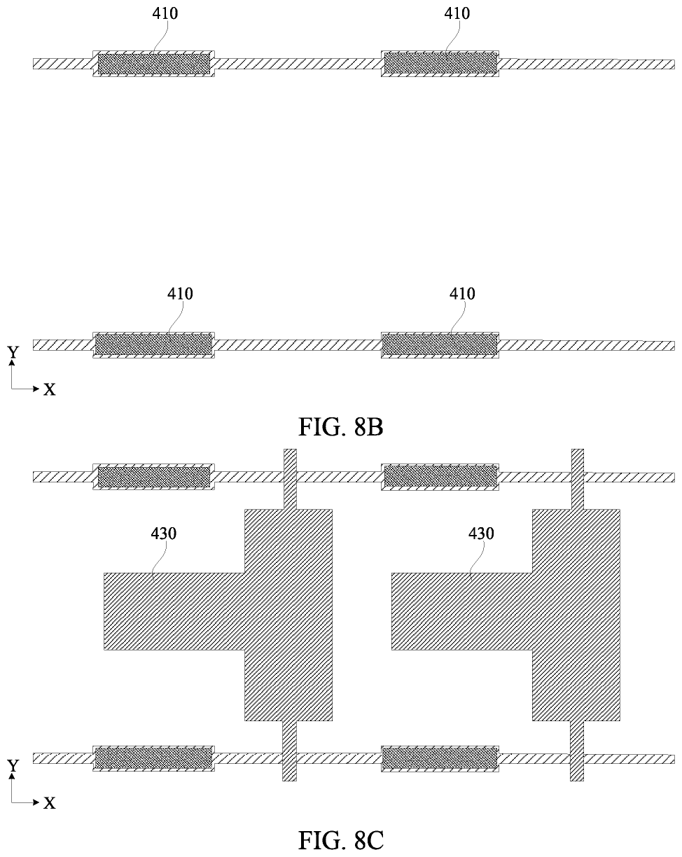

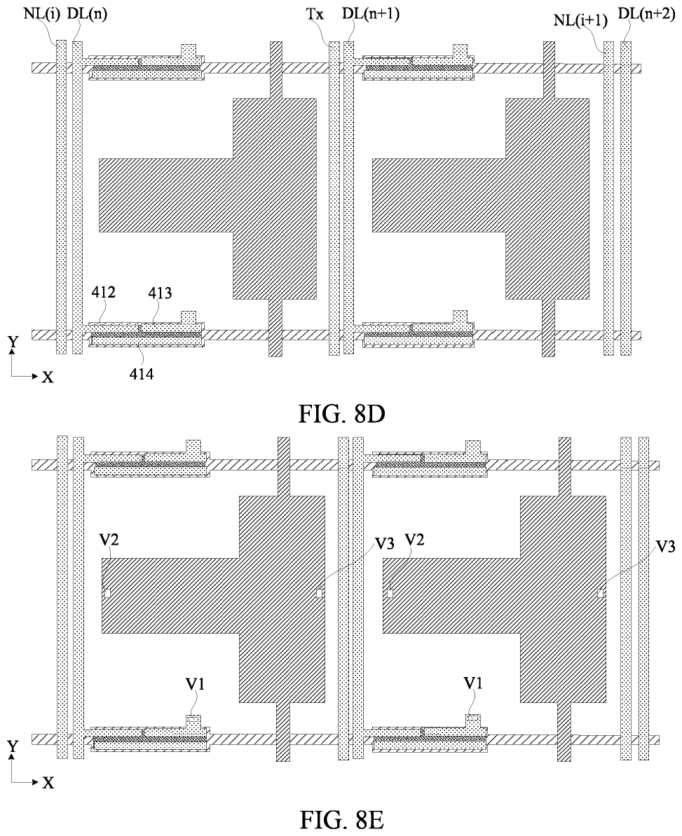

FIG. 8A is a partial schematic diagram of the circuit structure layer after a first conductive layer is formed in FIG. 6. In some examples, as shown in FIG. 6 to FIG. 8A, the first conductive layer 41 may include a gate 411 of a transistor T1 of a drive unit, and the plurality of first signal lines (including, for example, scan lines GL (m) and GL (m+1)) extending in the first direction X. The gates 411 of a plurality of transistors T1 in which the first signal lines are connected in a same row may be an integrated structure.

FIG. 8B is a partial schematic diagram of the circuit structure layer after a semiconductor layer is formed in FIG. 6. In some examples, as shown in FIG. 6 to FIG. 8B, the semiconductor layer 40 may include an active layer 410 of the transistor T1. An orthographic projection (e.g., may be rectangular) of the active layer 410 of the transistor T1 on the base substrate may be overlapped with an orthographic projection of the gate 411 on the base substrate.

FIG. 8C is a partial schematic diagram of the circuit structure layer after a first transparent conductive layer is formed in FIG. 6. In some examples, as shown in FIG. 6 to FIG. 8C, the first transparent conductive layer 42 may include a plurality of touch electrodes 430. An orthographic projection of the touch electrodes 430 in the sub-pixel area on the base substrate may be in a T shape. The plurality of touch electrodes 430 adjacent in the second direction Y may be of an integrated structure.

FIG. 8D is a partial schematic diagram of the circuit structure layer after a second conductive layer is formed in FIG. 6. In some examples, as shown in FIG. 6 to FIG. 8D, the second conductive layer 43 may include a first electrode 412, a second electrode 413, and a third electrode 414 of the transistor T1, a plurality of second signal lines (e.g., data lines DL (n) to DL (n+2)), a touch signal line Tx, and a plurality of second communication lines (e.g., NL (i) and NL (i+1)). Orthographic projections of the first electrode 411, the second electrode 413 and the third electrode 414 of the transistor T1 on the base substrate are overlapped with the orthographic projection of the active layer 410 on the base substrate. The first electrode 412, the second electrode 413, and the third electrode 414 of the transistor T1 are all in direct contact with the active layer 410. The first electrode 412 of the transistor T1 and a data line electrically connected (for example, data line DL (n)) may be of an integrated structure, the second electrode 413 of the transistor T1 may be electrically connected with the pixel electrode 420 subsequently, and an orthographic projection of the third electrode 414 of the transistor T1 on the base substrate may be located on a same side of the first electrode 412 and the second electrode 413 in the second direction Y. By providing the third electrode 414, when the transistor T1 is turned on under the control of the gate 411, conduction between the first electrode 412 and the second electrode 413 is facilitated.

FIG. 8E is a partial schematic diagram of the circuit structure layer after a third insulation layer is formed in FIG. 6. In some examples, as shown in FIG. 6 to FIG. 8E, the third insulation layer 303 may be provided with a plurality of vias, which may include, for example, a first via V1 to a third via V3. The third insulation layer 303 and the second insulation layer 302 within the first via V1 may be removed to expose a surface of the second electrode 413 of the transistor T1. The third insulation layer 303 and the second insulation layer 302 within the second via V2 and the third via V3 are removed to expose a surface of the touch electrode 430. Orthographic projections of the second via V2 and the third via V3 on the base substrate may be located at both ends of the touch electrode 430 along the first direction X.

In some examples, as shown in FIG. 6 to FIG. 8E, the second transparent conductive layer 44 may include a plurality of pixel electrodes 420 and a plurality of second connection electrodes 440. The pixel electrode 420 may be located within the sub-pixel region. The pixel electrode 420 may be electrically connected with a second electrode 413 of a transistor T1 through a first via V1. The second connection electrode 440 may extend along the first direction X. One end of the second connection electrode 440 can be electrically connected with the touch electrode 430 in one sub-pixel area through the second via V2, and can be electrically connected with the touch electrode 430 in another sub-pixel area, thereby implementing the electrical connection between two adjacent touch electrodes 430 arranged along the first direction X. An orthographic projection of a second connection electrode 440 on the base substrate may be overlapped with orthographic projections of a touch signal line Tx and a data line on the base substrate, or may be overlapped with orthographic projections of a data line and a second communication line on the base substrate.

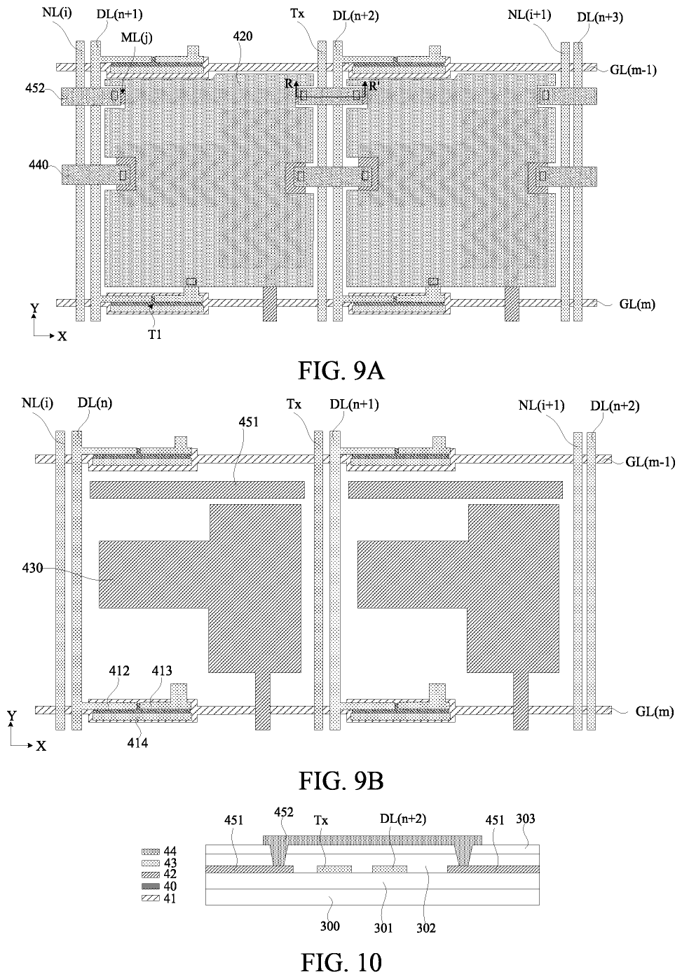

FIG. 9A is a partial schematic diagram of a circuit structure layer of a display area according to at least one embodiment of the present disclosure. FIG. 9A is a schematic diagram of two sub-pixel areas of first row, second column and first row, third column in FIG. 4. FIG. 9B is a schematic diagram of the circuit structure layer after a second conductive layer is formed in FIG. 9A. FIG. 10 is a schematic partial sectional view along an R-R′ direction in FIG. 9A.

In some examples, as shown in FIG. 9A and FIG. 9B, taking a first communication line ML (j) as an example, the first communication line ML (j) may include a plurality of first sub-communication line segments 451 sequentially arranged along the first direction X. A first sub-communication line segment 451 may be located within a sub-pixel area. Adjacent first sub-communication line segments 451 may be electrically connected through first connection electrodes 452. The first sub-communication line segment 451 may be a strip-shaped line and may be located on a side of the touch electrode 430 along the second direction Y within a sub-pixel area. As shown in FIG. 10, the first sub-communication line segment 451 may be located in a first transparent conductive layer. The first sub-communication line segment 451 and the touch electrode 430 may be in a same layer.

In some examples, as shown in FIG. 9A to FIG. 10, the first connection electrode 452 may be located in a second transparent conductive layer. The first connection electrode 452 and a pixel electrode 420 may be in a same layer. One end of the first connection electrode 452 may be electrically connected with one first sub-communication line segment 451 through a via provided by the third insulation layer 303 and the second insulation layer 302, and the other end of the first connection electrode 452 may be electrically connected with another first sub-communication line segment 451 through another via. An orthographic projection of the first connection electrode 452 on the base substrate may be overlapped with orthographic projections of a touch signal line Tx and a data line on the base substrate, or may be overlapped with orthographic projections of a data line and a second communication line on the base substrate. The first connection electrode 452 implements electrical connection between two adjacent first sub-communication line segments 451 by crossing two lines extending along the second direction Y located in the second conductive layer.

This example implements signal transmission of the first communication line in the first direction X by disposing a first communication line in the first transparent conductive layer and electrically connecting through the first connection electrode located in the second transparent conductive layer. The pixel electrode of this example is located in the second transparent conductive layer, and the second insulation layer and the third insulation layer are disposed between the pixel electrode and the near field communication coil, which can effectively reduce the capacitive coupling effect between the pixel electrode and the near field communication coil under a heavy-duty picture, thereby alleviating the adverse influence of the near field communication on the display.

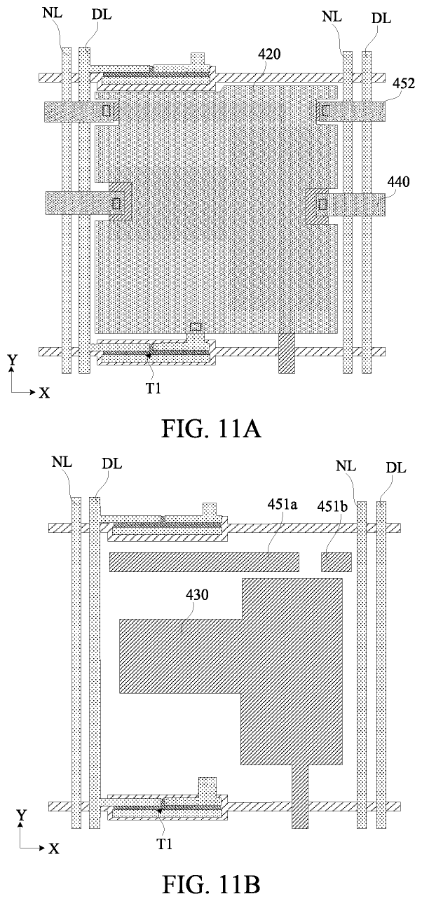

FIG. 11A is a partial schematic diagram of a circuit structure layer of a display area according to at least one embodiment of the present disclosure. FIG. 11B is a schematic diagram of the circuit structure layer after a second conductive layer is formed in FIG. 11A. FIG. 11A is a schematic diagram of a circuit structure layer of a sub-pixel area of a near field communication area adjacent to a non-near field communication area of a display area.

In some examples, as shown in FIG. 11A and FIG. 11B, the first sub-communication line segment within a sub-pixel area within the near field communication area adjacent to the non-near field communication area may include a first line segment 451a and a second line segment 451b. The first line segment 451a and the second line segment 451b may be disconnected. One end of the first line segment 451a may be electrically connected with another first sub-communication line segment within the near field communication area through a first connection electrode 452. The second line segment 451b may be electrically connected with a first dummy communication line within a non-near field communication area through a first connection electrode 452. A disposing mode of the first dummy communication line in the non-near field communication area may be substantially the same as a disposing mode of the first communication line in the near field communication area, and will not be repeated herein. In this example, the first communication line is disconnected from the first dummy communication line, which may be achieved by disconnecting a portion of the first communication line, and influence on the display of the non-near field communication area may be avoided. However, this embodiment is not limited thereto. In some other examples, the first communication line and the first dummy communication line may not be electrically connected through the first connection electrode thereby achieving disconnection of both.

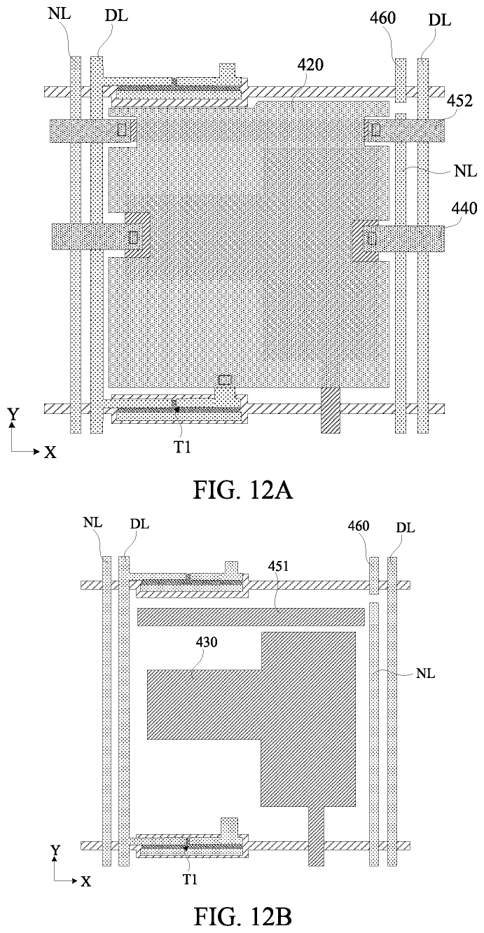

FIG. 12A is another partial schematic diagram of a circuit structure layer of a display area according to at least one embodiment of the present disclosure. FIG. 12B is a schematic diagram of the circuit structure layer after a second conductive layer is formed in FIG. 12A. FIG. 12A is a schematic diagram of the circuit structure layer of a sub-pixel area of a near field communication area adjacent to a non-near field communication area of a display area.

In some examples, as shown in FIG. 12A and FIG. 12B, a second communication line NL within a sub-pixel area within the near field communication area adjacent to the non-near field communication area and a second dummy communication line 460 within the non-near field communication area may be disconnected. The second dummy communication line 460 may receive a common voltage Vcom. A disposing mode of the second dummy communication line in the non-near field communication area may be substantially the same as a disposing mode of the second communication line in the near field communication area, and will not be repeated herein. In this example, the second communication line is disconnected from the second dummy communication line, so that the influence on the display of the non-near field communication area can be avoided.

Exemplary description is made below through a manufacturing process for a display substrate. The “patterning process” or “a process of patterning” mentioned in the present disclosure includes processes, such as photoresist coating, mask exposure, development, etching and photoresist stripping, for metal materials, inorganic materials or transparent conductive materials, and includes processes, such as organic material coating, mask exposure and development, for organic materials. Deposition may be any one or more of sputtering, evaporation, and chemical vapor deposition. Coating may be any one or more of spray coating, spin coating, and ink-jet printing. Etching may be any one or more of dry etching and wet etching, which is not limited in the present disclosure. A “thin film” refers to a layer of thin film made of a certain material on a base substrate through a process such as deposition, coating, etc. If the “thin film” does not need a patterning process in an entire preparation process, the “thin film” may also be called a “layer”. If the “thin film” needs a patterning process in an entire preparation process, it is called a “thin film” before the patterning process, and called a “layer” after the patterning process. The “layer” after the patterning process includes at least one “pattern”.

“E and F are disposed on a same layer” in the present disclosure means that E and F are formed simultaneously by a same patterning process or that surfaces of E and F near the base substrate are at substantially same distance from the base substrate, or that the surfaces of E and F near the base substrate are in direct contact with a same film layer. The “thickness” of a film layer is a size of the film layer in a direction perpendicular to a plane where the substrate is located. In an exemplary embodiment of the present disclosure, “an orthogonal projection of E includes an orthogonal projection of F” refers to that a boundary of the orthogonal projection of E falls within a boundary of the orthogonal projection of F, or the boundary of the orthogonal projection of E is coincided with the boundary of the orthogonal projection of F.

In some exemplary embodiments, the manufacturing process of the display substrate may include following acts.

(1) Providing a base substrate. In some examples, the base substrate may be a transparent substrate, for example, a quartz substrate, a glass substrate or an organic resin substrate. However, this embodiment is not limited thereto.

(2) Forming a first conductive layer. In some examples, a first conductive thin film is deposited on the base substrate, and the first conductive thin film is patterned through a patterning process to form the first conductive layer. As shown in FIG. 8A, the first conductive layer may include at least a gate 411 of the transistor T1 and a plurality of first signal lines (e.g., scan lines).

(3) Forming a semiconductor layer. In some examples, a first insulation thin film and a semiconductor thin film are deposited sequentially on the base substrate, on which the aforementioned structure is formed, and the semiconductor thin film is patterned through a patterning process to form a first insulation layer and the semiconductor layer disposed on the first insulation layer. As shown in FIG. 8B, the semiconductor layer may include an active layer 410 of the transistor T1.

(4) Forming a first transparent conductive layer. In some examples, a first transparent conductive thin film is deposited on the base substrate, on which the aforementioned structure is formed, and the first transparent conductive thin film is patterned through a patterning process to form a first transparent conductive layer. As shown in FIG. 8C, the first transparent conductive layer may include a plurality of touch electrodes 430.

(5) Forming a second conductive layer. In some examples, a second conductive thin film is deposited on the base substrate, on which the aforementioned structure is formed, and the second insulation thin film is patterned through a patterning process to form the second conductive layer. As shown in FIG. 8D, the second conductive layer may include a first electrode 412, a second electrode 413, and a third electrode 414 of the transistor T1, a plurality of second signal lines (e.g., data lines), touch signal lines, and a plurality of second communication lines.

(6) Forming a second insulation layer and a third insulation layer. In some examples, a second insulation thin film is deposited on the base substrate, on which the aforementioned structure is formed, and subsequently, a third insulation thin film is coated, and the third insulation thin film is patterned through a patterning process to form the third insulation layer, and the second insulation thin film is patterned through a patterning process to form the second insulation layer. In some examples, as shown in FIG. 8E, the third insulation layer and the second insulation layer may be provided with a plurality of vias.

(7) Forming a second transparent conductive layer. In some examples, a second transparent conductive thin film is deposited on the base substrate, on which the aforementioned structure is formed, and the second transparent conductive thin film is patterned through a patterning process to form the second transparent conductive layer. In some examples, as shown in FIG. 6, FIG. 9A, FIG. 11A, and FIG. 12A, the second transparent conductive layer may include a plurality of pixel electrodes 420, a plurality of first connection electrodes 452, and a plurality of second connection electrodes 440.

At this point, the circuit structure layer can be manufactured. Subsequently, the electronic paper film may be attached to a side of the circuit structure layer away from the base substrate by pasting.

In some exemplary embodiments, the first insulation layer 301 and the second insulation layer 302 may be made of any one or more of silicon oxide (SiOx), silicon nitride (SiNx) and silicon oxynitride (SiON), and may be a single-layer, multi-layers or a composite layer. The third insulation layer 303 may be made of an organic material. The first conductive thin film and the second conductive thin film may be made of a metal material, such as any one or more of Argentum (Ag), Copper (Cu), Aluminum (Al), Titanium (Ti), and Molybdenum (Mo), or an alloy material of the aforementioned metals, such as an Aluminum-Neodymium alloy (AlNd) or a Molybdenum-Niobium alloy (MoNb), and may be of a single layer structure, or a multi-layer composite structure such as Ti/Al/Ti, etc. The first transparent conductive thin film and the second transparent conductive thin film may be made of a transparent conductive material such as indium tin oxide (ITO) or indium zinc oxide (IZO), etc. However, this embodiment is not limited thereto.

The structure of the display substrate of an embodiment of the present disclosure and the manufacturing process thereof are described only as an example. In some exemplary embodiments, a corresponding structure may be changed and a patterning process may be increased or decreased according to actual needs.

The display substrate provided in this example can achieve the integration of touch function and NFC function in EPD display products by adding near field communication coils in the circuit structure layer, thus enhancing the competitiveness of products. Moreover, the embodiment does not need to increase the film layer and the manufacturing process, does not increase the cost of the mask plate, and is beneficial to reduce the cost. In addition, the display substrate of this embodiment can be used upside down when in use, that is, when in use, a side of the base substrate faces the user, touch operation is performed on a side of the base substrate, and electronic paper film is used to display through the base substrate, so that the light transmittance of the display product will not be affected.

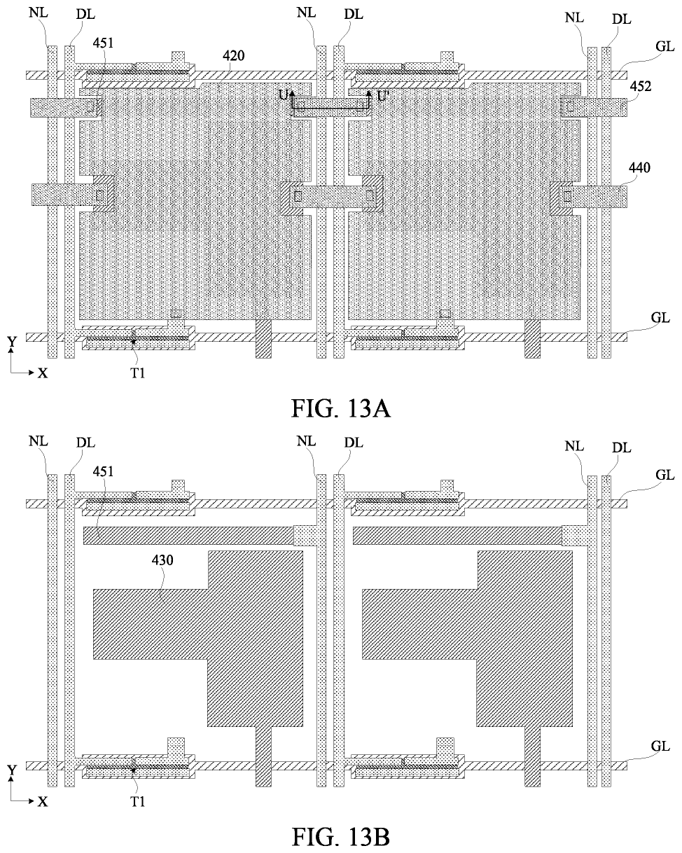

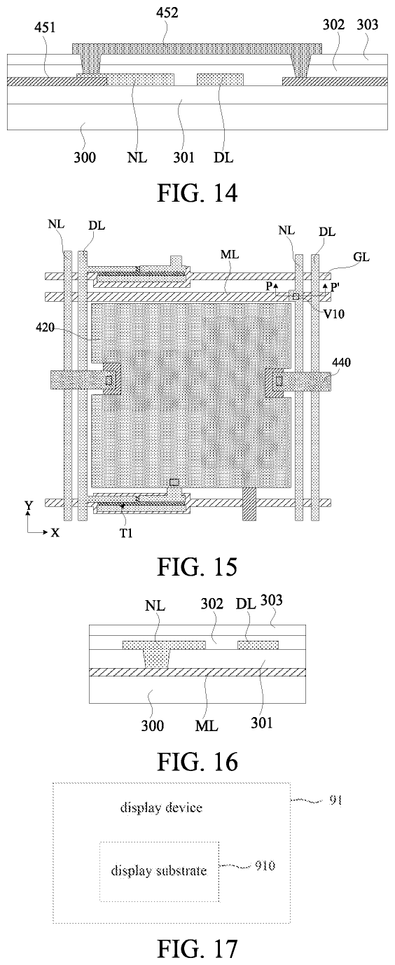

FIG. 13A is another schematic diagram of a circuit structure layer of a display area according to at least one embodiment of the present disclosure. FIG. 13B is a schematic diagram of the circuit structure layer after a second conductive layer is formed in FIG. 13A. FIG. 14 is a partially enlarged schematic diagram along a U-U′ direction in FIG. 13A. FIG. 13A illustrates a structure of two adjacent sub-pixel areas within the near field communication area.

In some examples, as shown in FIG. 13A to FIG. 14, an orthographic projection of at least one second communication line NL on the base substrate may be overlapped with an orthographic projection of the first sub-communication segment 451 of the first communication line on the base substrate. The second communication line NL may be in direct contact with the first sub-communication segment 451 to achieve electrical connection. One end of the first connection electrode 451 may be electrically connected with the second communication line NL, and the other end may be electrically connected with another first sub-communication line segment 451, thereby achieving an electrical connection of adjacent first sub-communication sub-line segments. In this example one end of the first sub-communication line segment 451 may be electrically connected with the first connection electrode 451 and the other end may be directly electrically connected with the second communication line NL. Regarding the rest of structure of the display substrate of this embodiment, reference may be made to the description of the aforementioned embodiments, and will not be repeated herein.

FIG. 15 is another schematic diagram of a circuit structure layer of a display area according to at least one embodiment of the present disclosure. FIG. 16 is a partially enlarged schematic diagram along a P-P′ direction in FIG. 15. FIG. 15 illustrates a structure of a sub-pixel area within the near field communication area.

In some examples, as shown in FIG. 15 and FIG. 16, the first communication line ML may be located in the first conductive layer. The second communication line NL may be located in the second conductive layer. The second communication line NL may be electrically connected with the first communication line ML through a via provided in the first insulation layer. Regarding the rest of structure of the display substrate of this embodiment, reference may be made to the description of the aforementioned embodiments, and will not be repeated herein.

An embodiment of the present disclosure further provides a manufacturing method for the display substrate, which includes the following acts: forming a circuit structure layer on the base substrate; an electronic paper film is disposed on a side of the circuit structure layer away from the base substrate. The circuit structure layer includes a plurality of first signal lines extending along the first direction, a plurality of second signal lines extending along the second direction, a plurality of drive units, and at least one near field communication coil. The first direction intersects with the second direction. The plurality of first signal lines 21 and the plurality of second signal lines 41 intersect to form a plurality of sub-pixel areas. The drive unit is located in the sub-pixel area and electrically connected with the first signal line and the second signal line. The near field communication coil includes at least one first communication line extending along the first direction and at least one second communication line extending along the second direction, the at least one first communication line is electrically connected with the at least one second communication line. The drive unit of the circuit structure layer is configured to control the display pattern of the electronic paper film corresponding to the sub-pixel area.

In some exemplary embodiment modes, forming a circuit structure layer on a base substrate may include sequentially forming a first conductive layer, a first insulation layer, a semiconductor layer, a first transparent conductive layer, a second conductive layer, a second insulation layer, a third insulation layer, and a second transparent conductive layer on the base substrate. The first conductive layer at least includes: the plurality of first signal lines, the gate of the transistor of the drive unit; the semiconductor layer at least includes: an active layer of the transistor of the drive unit; the first transparent conductive layer at least includes a plurality of touch electrodes; the second conductive layer at least includes: the plurality of second signal lines, the at least one second communication line and the plurality of touch signal lines, the first electrode and the second electrode of the transistor of the drive unit; the second transparent conductive layer at least includes the plurality of pixel electrodes.

In some exemplary embodiments, the transistor of the drive unit and the first signal line are of an integrated structure, the first electrode of the transistor of the drive unit and the second signal line are of an integrated structure, and the second electrode of the transistor is electrically connected with the pixel electrode.

For the process for manufacturing the display substrate provided in this embodiment, reference may be made to descriptions of the aforementioned embodiments, and will not be repeated herein.

An embodiment of the present disclosure further provides a display device, which includes the aforementioned display substrate.

FIG. 17 is a schematic diagram of a display device according to at least one embodiment of the present disclosure. As shown in FIG. 17, a display device 900 according to this embodiment includes a display substrate 910. The display substrate 910 may be the display substrate provided in the aforementioned embodiments. In some examples, the display substrate 910 may be an EPD panel. The display device 900 may be any product or component with a display function, such as an EPD display device, an electronic tag, or the like. However, this embodiment is not limited thereto.

The drawings of the present disclosure only involve structures involved in the present disclosure, and other structures may refer to conventional designs. The embodiments of the present disclosure and features in the embodiments may be combined to each other to obtain new embodiments if there is no conflict. Those of ordinary skills in the art should understand that modifications or equivalent replacements may be made on the technical solutions of the present disclosure without departing from the spirit and scope of the technical solutions of the present disclosure, and shall all fall within the scope of the claims of the present disclosure.

1. A display substrate, comprising:
a base substrate; and a circuit structure layer and an electronic paper film sequentially disposed on the base substrate, wherein:
the circuit structure layer comprises: a plurality of first signal lines extending along a first direction; a plurality of second signal lines extending along a second direction; a plurality of drive units; and at least one near field communication coil, wherein the first direction is intersected with the second direction; the plurality of first signal lines and the plurality of second signal lines are intersected to form a plurality of sub-pixel areas; the drive units are located in the sub-pixel area and electrically connected with the first signal lines and the second signal lines, and the drive units are configured to control display patterns of the electronic paper film corresponding to the sub-pixel areas; and
the near field communication coil comprises at least one first communication line extending along the first direction and at least one second communication line extending along the second direction, wherein the at least one first communication line is electrically connected with the at least one second communication line.

2. The display substrate according to claim 1, wherein at least one first signal line is adjacent to the first communication line in the second direction, and at least one second signal line is adjacent to the second communication line in the first direction.

3. The display substrate according to claim 1, wherein at least one sub-pixel area is spaced between two adjacent first communication lines in the second direction and at least one sub-pixel area is spaced between two adjacent second communication lines in the first direction.

4. The display substrate according to claim 1, wherein the at least one first communication line is located on a side of the at least one second communication line close to the base substrate; the plurality of first signal lines are located on a side of the plurality of second signal lines close to the base substrate.

5. The display substrate according to claim 1, wherein the at least one second communication line and the plurality of second signal lines are in a same layer.

6. The display substrate according to claim 4, wherein the at least one first communication line and the plurality of first signal lines are in a same layer.

7. The display substrate according to claim 4, wherein the at least one first communication line is located on a side of the plurality of first signal lines away from the base substrate.

8. The display substrate according to claim 1, wherein the at least one first communication line comprises a plurality of first sub-communication line segments extending along the first direction and sequentially arranged, two adjacent first sub-communication line segments are electrically connected by a first connection electrode located on a side of the first sub-communication line segment away from the base substrate.

9. The display substrate according to claim 1, wherein the base substrate comprises: at least one near field communication area and at least one non-near field communication area, wherein the at least one near field communication coil is located within the at least one near field communication area, and the at least one non-near field communication area is provided with at least one first dummy communication line extending along the first direction and at least one second dummy communication line extending along the second direction; the first communication line is disconnected from the first dummy communication line, and the second communication line is disconnected from the second dummy communication line.

10. The display substrate according to claim 1, wherein the circuit structure layer further comprises: a plurality of touch signal lines and a plurality of touch electrodes; the plurality of touch signal lines extend along the second direction, and at least one touch signal line is electrically connected with the plurality of touch electrodes electrically connected with each other and spaced apart.

11. The display substrate according to claim 10, wherein the at least one second communication line is arranged at intervals among the plurality of touch signal lines, and at least one sub-pixel area is spaced between a second communication line and a touch signal line adjacent to each other.

12. The display substrate according to claim 10, wherein at least one drive unit of the plurality of drive units at least comprises: a transistor and a pixel electrode, the pixel electrode is located in at least one sub-pixel area of the plurality of sub-pixel areas; a gate of the transistor is electrically connected with at least one first signal line of the plurality of first signal lines, a first electrode of the transistor is electrically connected with at least one second signal line of the plurality of second signal lines, and a second electrode of the transistor is electrically connected with the pixel electrode.

13. The display substrate according to claim 12, wherein:
in a direction perpendicular to the display substrate, the circuit structure layer comprises a first conductive layer, a semiconductor layer, a first transparent conductive layer, a second conductive layer, and a second transparent conductive layer which are disposed sequentially on the base substrate;
the first conductive layer at least comprises: the plurality of first signal lines, gates of transistors of the drive units;
the semiconductor layer at least comprises: active layers of the transistors of the drive units;
the first transparent conductive layer comprises: the plurality of touch electrodes;
the second conductive layer at least comprises: the plurality of second signal lines, the at least one second communication line and the plurality of touch signal lines; and
the second transparent conductive layer at least comprises: pixel electrodes of the drive units.

14. The display substrate according to claim 13, wherein the at least one first communication line is located in the first conductive layer or located in the first transparent conductive layer.

15. The display substrate according to claim 14, wherein an inorganic insulation layer and an organic insulation layer are disposed between the second conductive layer and the transparent conductive layer, the organic insulation layer is located on a side of the inorganic insulation layer away from the base substrate.

16. The display substrate according to claim 1, wherein the electronic paper film is configured to display using incident light from a side of the base substrate.

17. A display device, comprising a display substrate according to claim 1.

18. A manufacturing method for a display substrate, comprising:
forming a circuit structure layer on a base substrate, wherein the circuit structure layer comprises a plurality of first signal lines extending along a first direction, a plurality of second signal lines extending along a second direction, a plurality of drive units, and at least one near field communication coil; the first direction is intersected with the second direction; the plurality of first signal lines and the plurality of second signal lines are intersected to form a plurality of sub-pixel areas; the drive units are located in the sub-pixel areas and electrically connected with the first signal lines and the second signal lines; the near field communication coil comprises: at least one first communication line extending along the first direction and at least one second communication line extending along the second direction, the at least one first communication line is electrically connected with the at least one second communication line; and
disposing an electronic paper film on a side of the circuit structure layer away from the base substrate, wherein the drive units of the circuit structure layer is configured to control the display patterns of the electronic paper film corresponding to the sub-pixel areas.

19. The manufacturing method according to claim 18, wherein:
forming the circuit structure layer on the base substrate comprises: forming a first conductive layer, a first insulation layer, a semiconductor layer, a first transparent conductive layer, a second conductive layer, a second insulation layer, a third insulation layer, and a second transparent conductive layer on the base substrate sequentially;
the first conductive layer at least comprises: the plurality of first signal lines, gates of transistors of the drive units;
the semiconductor layer at least comprises: active layers of the transistors of the drive units;
the first transparent conductive layer comprises: a plurality of touch electrodes;
the second conductive layer at least comprises: the plurality of second signal lines, the at least one second communication line and a plurality of touch signal lines, first electrodes and second electrodes of the transistors of the drive units; and
the second transparent conductive layer at least comprises: a plurality of pixel electrodes of the drive units.

20. The manufacturing method according to claim 19, wherein the transistors of the drive units and the first signal lines are of an integrated structure, the first electrodes of the transistors of the drive units and the second signal lines are of an integrated structure, and the second electrodes of the transistors are electrically connected with the pixel electrodes.
